(19) United States
(12) Patent Application Publication
(10) Pub. No.: US 2014/0366148 A1
(43) Pub. Date: Dec. 11, 2014

(54) Storage Medium Securing Method and Media Access Device thereof

(71) Applicant: Transcend Information, Inc., Taipei (TW)

(72) Inventors: Tsang-Yi Chen, New Taipei City (TW); Kuo-Chi Hsu, Chiayi City (TW)

(21) Appl. No.: 13/913,531

(22) Filed: Jun. 10, 2013

(51) Int. Cl. G06F 21/60

(52) U.S. Cl. CPC G06F 21/60
USPC 726/26

(57) ABSTRACT

By disabling at least one data transmission port of a media access device when the media access device is connected to a storage medium under an encrypted state and when the media access device is capable of performing decryption corresponding to an encryption mechanism applied on the storage medium, data security of the storage medium can be secured.

### BACKGROUND

1. Technical Field

The present invention relates to a storage medium securing method and a media access device, and more particularly, to a storage medium securing method for securing contents stored in a storage medium and a media access device applying the storage medium securing method.

2. Description of the Conventional Art

Data security of a storage medium is highly required to be fulfilled, especially when the storage medium stores confidential information about a holder of the storage medium. However, every time when the storage medium is connected to a media access device that has an external data transmission with a computer, the data security of the storage medium may be breached by the external data transmission, especially when a Trojan horse virus has been hidden in the computer.

Please refer to FIG. 1, which illustrates how the data security of a storage medium 130 is breached when the storage medium 130 is connected to a conventional media access device 120. As shown in FIG. 1, when a user of a computer 110 would like to access data stored in the storage medium 130, he or she may connect the storage medium 130 with the media access device 120 via a data transmission port DS3 of the media access device 120, and may connect the computer 110 with the media access device 120 via a data transmission port DS1 of the computer 110 and a data transmission port DS2 of the media access device 120, so that the user is able to browse contents stored in the storage medium 130 via a first data transmission between the data transmission ports DS1 and DS2 and via a second data transmission between the data transmission port DS3 and the storage medium 130. Note that the user may also directly browse the contents on the media access device 120, which is assumed to have a display.

However, if the computer 110 is also connected to an external network, and if a Trojan horse virus has been hidden on the computer 110, confidential contents stored in the storage medium 130 may be externally transmitted via the external network by the Trojan horse virus without being aware of by the user of the computer 110. And as a result, the data security of the storage medium 130 is breached.

### SUMMARY

The claimed invention discloses a storage medium securing method, which comprises: confirming whether a storage medium is under an encrypted state when the storage medium is connected to a media access device; confirming whether the media access device is capable of performing decryption corresponding to an encryption mechanism applied on the storage medium when the storage medium is confirmed to be under the encrypted state; and disabling at least one data transmission port of the media access device when the media access device is confirmed to be capable of performing the decryption corresponding to the encryption mechanism.

The claimed invention further discloses a media access device, which comprises a plurality of data transmission ports and a controller. The controller is configured to confirm whether a storage medium is under an encrypted state when the storage medium is connected to one of the plurality of data transmission ports, is configured to confirm whether the media access device is capable of performing decryption corresponding to an encryption mechanism applied on the storage medium when the storage medium is confirmed to be under the encrypted state, and is configured to disable at least one of the plurality of data transmission ports when the media access device is confirmed to be capable of performing the decryption corresponding to the encryption mechanism.

The claimed invention further discloses a storage medium securing method, which comprises confirming whether a storage medium is under an encrypted state when the storage medium is connected to a media access device; confirming whether the media access device is capable of performing decryption corresponding to an encryption mechanism applied on the storage medium when the storage medium is confirmed to be under the encrypted state; and disabling at least one hardware function of the media access device to prevent data stored in the storage medium from being accessed by any device other than the media access device when the media access device is confirmed to be capable of performing the decryption corresponding to the encryption mechanism.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates how the data security of a storage medium is breached when the storage medium is connected to a conventional media access device.

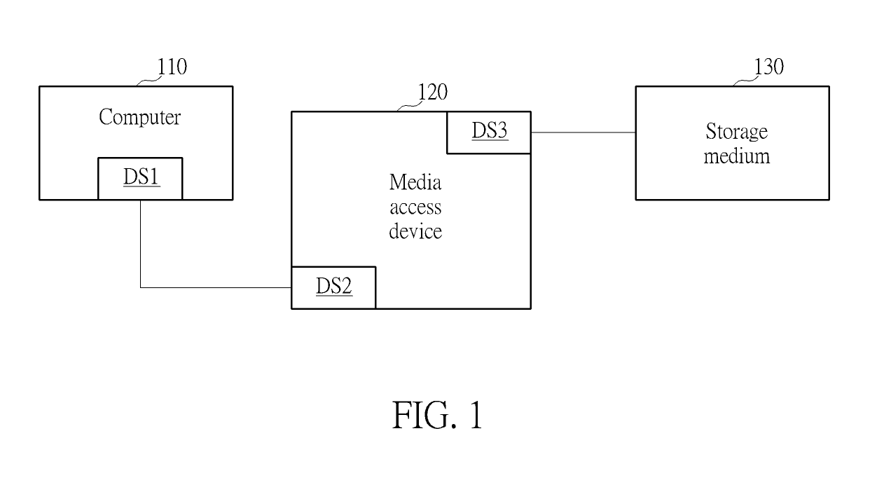

FIG. 2 discloses a media access device and how the media access device secures a storage medium from malicious data breaches according to one embodiment of the present invention.

FIG. 3 illustrates the storage medium securing method according to one embodiment of the present invention.

### DETAILED DESCRIPTION

For securing the data security of a storage medium from being breached, especially by a malicious Trojan horse virus, the present invention discloses a storage medium securing method and a media access device applying the disclosed storage medium securing method.

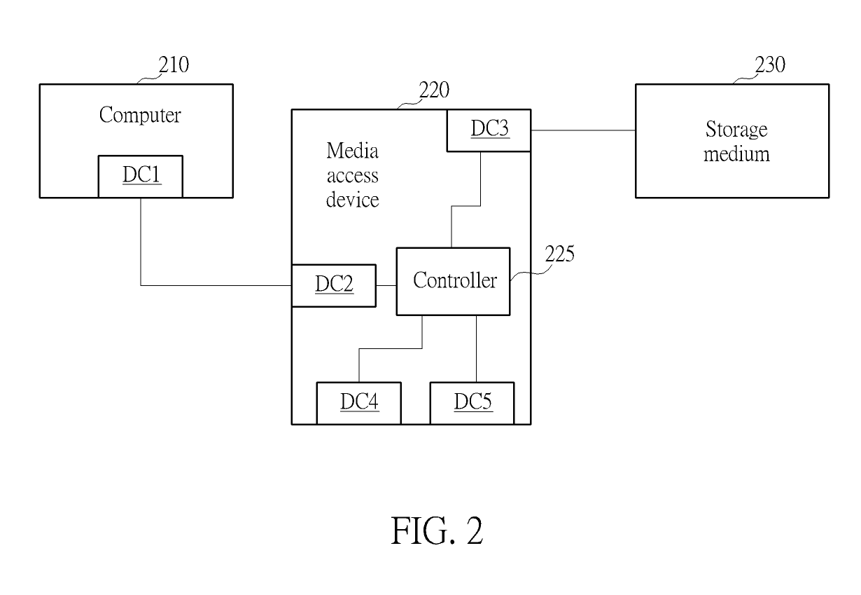

Please refer to FIG. 2, which discloses a media access device 220 and how the media access device 220 secures a storage medium 230 from malicious data breaches according to one embodiment of the present invention.

As shown in FIG. 2, a computer 210 is optionally connected to the media access device 220 via a data transmission port DC1 of the computer 210 and a data transmission port DC2 of the media access device 220, and the storage medium 230 is optionally connected to the media access device 220 via a data transmission port DC3 of the media access device 220. The media access device 220 also has a controller 225 electrically connecting to all the data transmission ports of the media access device 220 for managing activate statuses of data transmission ports of the media access device 220, including the currently-utilized data transmission ports DC2 and DC3 and currently-unutilized data transmission ports DC4 and DC5 of the media access device 220. In some embodiments of the present invention, the media access device 220 may be a smart-phone, a multimedia player capable of playing multimedia files such as MP3 or MP4 files, or a tablet computer. The media access device 220 is especially capable of independently playing files stored in the storage medium 230. In some embodiments of the present invention, the media storage medium 230 may be a memory card or a portable storage device, and the media storage medium 230 is capable of securing data stored in the media storage medium 230 by encrypting the stored data. Besides, the data transmission ports of the media access device 220 may include at least one wired port and/or at least one wireless port.

How the media access device 220 secures the data security of the storage medium 230 is explained in the following descriptions. At the time when the storage medium 230 is connected to the media access device 220, for example, manually, the controller 225 of the media access device 220 is configured to confirm whether the storage medium 230 is under an encrypted state. The encrypted state may indicate that data stored in the storage medium 230 is encrypted via a secure-specific command CMD42 regulated by a protocol of the Secure Digital Memory Card, or is encrypted via a conventional encryption/decryption software utilized by the storage medium 230 when the storage medium 230 is a conventional portable storage device. In one preferred embodiment of the present invention, the media access device 220 is capable of utilizing a decryption mechanism in response to any encryption mechanism utilized by the storage medium 230 to form the encrypted state.

If the storage medium 230 is confirmed to be under an encrypted state by the controller 225, the controller 225 is further configured to confirm an encryption mechanism applied on the storage medium 230. After a type of the encryption mechanism is confirmed by the controller 225, the controller 225 is configured to disable at least one of the data transmission ports DC2, DC4, and DC5, where the data transmission port DC3 is excluded from the disable list of the controller 220 since the data transmission port DC3 is currently responsible for the data connection with the storage medium 230. After the controller 225 disables at least one of the data transmission ports DC2, DC4, and DC5, the controller 225 is configured to utilize a decryption mechanism, which is corresponding to the confirmed encryption mechanism and is pre-stored in a memory of the media access device 220, to decrypt at least one encrypted file stored in the storage medium 230 for generating at least one decrypted file. At last, the controller 225 is configured to access the least one decrypted file in response to a user command issued to the media access device 220, for example, a touch command on a touch screen disposed on the media access device 220, for browsing.

Note that the controller 225 is capable of disabling the at least one of the data transmission ports DC2, DC4, and DC5 by disabling at least one hardware function acquired by the media access device 220 and utilized for using the at least one data transmission port DC2, DC4, and DC5 of the media access device 220 for data transmission.

Note that in one embodiment of the present invention, the controller 225 is also capable of directly disabling at least one hardware function acquired by the media access device 220 for preventing data stored in the storage medium 230 from being accessed by any device other than the media access device 220 when the media access device 220 is confirmed by the controller 225 to be capable of performing the decryption corresponding to the encryption mechanism, where the any device maybe in a wired manner or wirelessly connected to the media access device 220 via at least one of the data transmission ports DC2, DC4, and DC5. The controller 225 maybe capable of directly disabling the at least one hardware function by disabling at least one of the data transmission ports DC2, DC4, and DC5 in one embodiment of the present invention.

Confirmation of the encryption mechanism by the controller 225 may include confirming an encryption algorithm utilized by the storage medium 230 and confirming whether the media access device 220 has a decryption key/code/software in its memory for performing decryption corresponding to the encryption algorithm. After the controller 225 confirms that the media access device 220 is capable of performing decryption corresponding to the encryption mechanism utilized by the storage medium 230, the controller 225 starts disabling at least one of the data transmission ports of the media access device 220.

If the storage medium 230 is confirmed not to be under the encrypted state, or if the controller 225 confirms that the media access device 220 is not capable of performing decryption corresponding to the encryption mechanism utilized by the storage medium 230, the controller 225 is configured not to disable any of the data transmission ports of the media access device 220.

The encrypted state of the storage medium 230 may be set via a hardware switch of the storage medium 230 or via the media access device 220 when the storage medium 230 was previously connected to the media access device 220.

In one embodiment of the present invention, suppose the computer 210 has been physically or wirelessly connected to the media access device 220 via the data transmission ports DC1 and DC2, after the controller 225 confirms that the storage medium 230 is under the encrypted state, the controller 225 is further configured to disable the data transmission port DC2, i.e., disable the data transmission between the computer 210 and the media access device 220. Therefore, even if there is a Trojan horse virus hidden in the computer 210 or a malicious intention for accessing the storage medium 230, any content stored on the storage medium 230 is currently inaccessible for the Trojan horse virus or the malicious intention so that the data security of the storage medium 230 is secured.

In one embodiment of the present invention, suppose the computer 210 has been physically or wirelessly connected to the media access device 220 via the data transmission ports DC1 and DC2, after the controller 225 confirms that the storage medium 230 is under the encrypted state, the controller 225 is further configured to disable all of the data transmission ports DC2, DC4, DC5 of the media access device 220 except for the data transmission port DC3. Therefore, no matter there is a Trojan horse virus hidden in the computer 210 or a malicious intention from the computer 210, or no matter there is at least one other device connected to the media access device 220 via the data transmission port DC4 or DC5 after the storage medium 230 is connected to and decrypted by the media access device 220, neither the computer 210 nor the at least one other device is capable of accessing the storage medium 230; that is, the storage medium 230 is only accessible for the media access device 220 at this time. As a result, the data security of the storage medium 230 can be better secured.

In one embodiment of the present invention, after the controller 225 confirms that the media access device 220 is capable of performing decryption corresponding to the encryption mechanism utilized by the storage medium 230 and disables the at least one data transmission port of the media access device 220, the controller 225 is further configured to confirm whether an identity of the storage medium 230 is recognizable for the media access device 220, under the supposition that the storage medium 230 and the media access device 220 were connected to each other for mutual identification before. If the identity of the storage medium 230 is recognizable for the media access device 220, the controller 225 is capable of directly decrypting at least one encrypted file stored in the storage medium 230 using the identity of the storage medium 230 for generating at least one decrypted file. Similarly at last, the controller 225 is configured to access the least one decrypted file in response to a user command issued to the media access device 220, for example, a touch command on a touch screen disposed on the media access device 220, for browsing.

In one embodiment of the present invention, after the controller 225 confirms that the media access device 220 is capable of performing decryption corresponding to the encryption mechanism utilized by the storage medium 230 and disables the at least one data transmission port of the media access device 220, the controller 225 is further configured to confirm whether an identity of at least one encrypted file stored in the storage medium 230 is recognizable for the media access device 220, under the supposition that the storage medium 230 and the media access device 220 were connected to each other for mutual identification before. If the identity of the at least one encrypted file is recognizable for the media access device 220, the controller 225 is capable of directly decrypting the at least one encrypted file using the identity of the at least one encrypted file for generating at least one decrypted file. Similarly at last, the controller 225 is configured to access the least one decrypted file in response to a user command issued to the media access device 220, for example, a touch command on a touch screen disposed on the media access device 220, for browsing.

In one embodiment of the present invention, besides confirming whether the identity of the storage medium 230 is recognizable for the media access device 220, the controller 225 is further configured to confirm whether an identity of at least one encrypted file stored in the storage medium 230 is recognizable for the media access device 220. After the controller 225 confirms that the identity of the storage medium 230 and the identity of at least one encrypted file are recognizable for the media access device 220, the controller 225 is capable of directly decrypting at least one encrypted file using the identity of the at least one encrypted file for generating at least one decrypted file. Similarly, the controller 225 is configured to access the least one decrypted file in response to a user command issued to the media access device 220, for example, a touch command on a touch screen disposed on the media access device 220, for browsing.

In some embodiments of the present invention, the storage medium 230 may be a SD card or a micro-SD card.

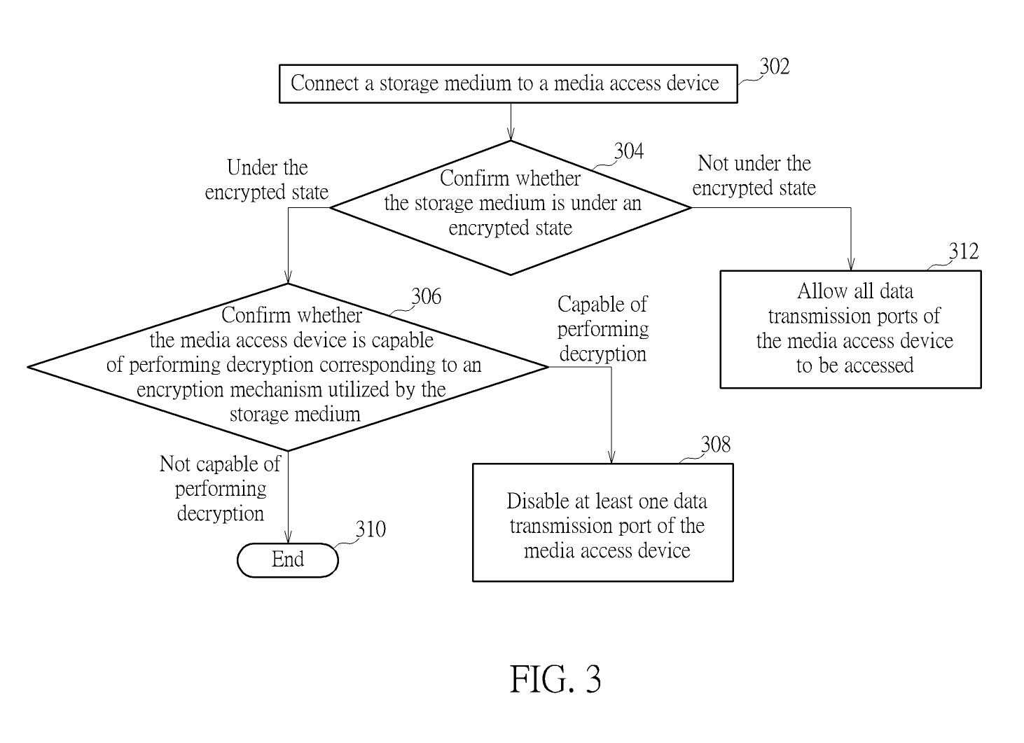

Please refer to FIG. 3, which illustrates the storage medium securing method according to one embodiment of the present invention and based on the above descriptions related to FIG. 2. As shown in FIG. 3, the storage medium securing method includes the following steps:

Step 302: Connect a storage medium 230 to a media access device 220.

Step 304: Confirm whether the storage medium 230 is under an encrypted state. When the storage medium 230 is confirmed to be under the encrypted state, go to Step 306; else, when the storage medium 230 is confirmed not to be under the encrypted state, go to Step 312.

Step 306: Confirm whether the media access device 220 is capable of performing decryption corresponding to an encryption mechanism utilized by the storage medium 230. When the media access device 220 is confirmed to be capable of performing decryption corresponding to the encryption mechanism, go to Step 308; else, go to Step 310.

Step 308: Disable at least one data transmission port of the media access device 220.

Step 310: End.

Step 312: Allow all data transmission ports of the media access device 220 to be accessed.

Embodiments formed by reasonable combination/permutation of the steps shown in FIG. 3 and/or by adding any abovementioned limitation should also be regarded as embodiments of the present invention.

The present invention discloses a storage medium securing method and a media access device applying the medium securing method. With the aid of the storage medium securing method and the media access device, when a storage medium is connected to the media access device, the data security of the storage medium can be well secured without being breached by a Trojan horse virus or any malicious intention from any device other than the media access device.

In some embodiments of the present invention, the at least one data transmission port of the media access device 220 maybe disabled by disabling at least one hardware function acquired by the media access device 220 and utilized for using the at least one data transmission port of the media access device 220 for data transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A storage medium securing method, comprising:
confirming whether a storage medium is under an encrypted state when the storage medium is connected to a media access device;
confirming whether the media access device is capable of performing decryption corresponding to an encryption mechanism applied on the storage medium when the storage medium is confirmed to be under the encrypted state; and
disabling at least one data transmission port of the media access device when the media access device is confirmed to be capable of performing the decryption corresponding to the encryption mechanism.

2. The method of claim 1, wherein the step of confirming whether the media access device is capable of performing the decryption corresponding to an encryption mechanism applied on the storage medium when the storage medium is confirmed to be under the encrypted state comprises:
confirming the encryption mechanism applied on the storage medium; and
confirming whether the media access device has a decryption key, a decryption code, or a decryption software for performing the decryption corresponding to the encryption mechanism applied on the storage medium.

3. The method of claim 2, further comprising:
decrypting at least one encrypted file, which is encrypted using the encryption mechanism and stored in the storage medium, by performing the decryption corresponding to the encryption mechanism to generate at least one decrypted file after the media access device is confirmed to have at least one of the decryption key, the decryption code, and the decryption software; and
accessing the at least one decrypted file in response to a user command of the media access device.

4. The method of claim 1, further comprising:
confirming whether an identity of the storage medium is recognizable for the media access device;
decrypting at least one encrypted file using the identity of the storage medium when the identity of the storage medium is confirmed to be recognizable for the media access device; and
accessing the at least one decrypted file in response to a user command of the media access device.

5. The method of claim 1, further comprising:
confirming whether an identity of at least one encrypted file stored in the storage medium is recognizable for the media access device;
decrypting at least one encrypted file using the identity of the at least one encrypted file when the identity of the at least one encrypted file is recognizable for the media access device; and
accessing the at least one decrypted file in response to a user command of the media access device.

6. The method of claim 1, before the step of confirming whether an identity of at least one encrypted file stored in the storage medium is recognizable for the media access device further comprising a step of: confirming whether an identity of the storage medium is recognizable for the media access device.

7. The method of claim 1, wherein the step of disabling the at least one data transmission port of the media access device when the media access device is confirmed to be capable of performing the decryption corresponding to the encryption mechanism comprises:
disabling at least one hardware function acquired by the media access device and utilized for using the at least one data transmission port of the media access device for data transmission.

8. A media access device, comprising:
a plurality of data transmission ports; and
a controller configured to confirm whether a storage medium is under an encrypted state when the storage medium is connected to one of the plurality of data transmission ports, configured to confirm whether the media access device is capable of performing decryption corresponding to an encryption mechanism applied on the storage medium when the storage medium is confirmed to be under the encrypted state, and configured to disable at least one of the plurality of data transmission ports when the media access device is confirmed to be capable of performing the decryption corresponding to the encryption mechanism.

9. The media access device of claim 8, wherein the controller is further configured to confirm the encryption mechanism applied on the storage medium and configured to confirm whether the media access device has a decryption key, a decryption code, or a decryption software for performing the decryption corresponding to the encryption mechanism applied on the storage medium.

10. The media access device of claim 9, wherein the controller is further configured to decrypt at least one encrypted file, which is encrypted using the encryption mechanism and stored in the storage medium, by performing the decryption corresponding to the encryption mechanism to generate at least one decrypted file after the media access device is confirmed to have at least one of the decryption key, the decryption code, and the decryption software, and configured to access the at least one decrypted file in response to a user command of the media access device.

11. The media access device of claim 8, wherein the controller is further configured to confirm whether an identity of the storage medium is recognizable for the media access device, to decrypt at least one encrypted file using the identity of the storage medium when the identity of the storage medium is confirmed to be recognizable for the media access device, and to access the at least one decrypted file in response to a user command of the media access device.

12. The media access device of claim 8, wherein the controller is further configured to confirm whether an identity of at least one encrypted file stored in the storage medium is recognizable for the media access device, to decrypt the at least one encrypted file using the identity of the at least one encrypted file when the identity of the at least one encrypted file is confirmed to be recognizable for the media access device, and to access the at least one decrypted file in response to a user command of the media access device.

13. The media access device of claim 11, wherein the controller is further configured to confirm whether an identity of the storage medium is recognizable for the media access device, to confirm whether an identity of at least one encrypted file stored in the storage medium is recognizable for the media access device when the identity of the storage medium is confirmed to be recognizable for the media access device, to decrypt at least one encrypted file using the identity of the at least one encrypted file when the identity of the at least one encrypted file is confirmed to be recognizable for the media access device, and to access the at least one decrypted file in response to a user command of the media access device.

14. The media access device of claim 8, wherein the controller is further configured to disable at least one hardware function acquired by the media access device and utilized for using the at least one data transmission port of the media access device for data transmission.

15. A storage medium securing method, comprising:
confirming whether a storage medium is under an encrypted state when the storage medium is connected to a media access device;
confirming whether the media access device is capable of performing decryption corresponding to an encryption mechanism applied on the storage medium when the storage medium is confirmed to be under the encrypted state; and
disabling at least one hardware function of the media access device to prevent data stored in the storage medium from being accessed by any device other than the media access device when the media access device is confirmed to be capable of performing the decryption corresponding to the encryption mechanism.

16. The method of claim 15, wherein the step of disabling at least one hardware function of the media access device comprises:
disabling at least one data transmission port of the media access device.

17. The method of claim 15, wherein the step of confirming whether the media access device is capable of performing the decryption corresponding to an encryption mechanism applied on the storage medium when the storage medium is confirmed to be under the encrypted state comprises:
confirming the encryption mechanism applied on the storage medium; and
confirming whether the media access device has a decryption key, a decryption code, or a decryption software for performing the decryption corresponding to the encryption mechanism applied on the storage medium.

18. The method of claim 15, further comprising:
decrypting at least one encrypted file, which is encrypted using the encryption mechanism and stored in the storage medium, by performing the decryption corresponding to the encryption mechanism to generate at least one decrypted file after the media access device is confirmed to have at least one of the decryption key, the decryption code, and the decryption software; and
accessing the at least one decrypted file in response to a user command of the media access device.

19. The method of claim 15, further comprising:
confirming whether an identity of the storage medium is recognizable for the media access device;
decrypting at least one encrypted file using the identity of the storage medium when the identity of the storage medium is confirmed to be recognizable for the media access device; and
accessing the at least one decrypted file in response to a user command of the media access device.

20. The method of claim 15, further comprising:
confirming whether an identity of the storage medium is recognizable for the media access device;
confirming whether an identity of at least one encrypted file stored in the storage medium is recognizable for the media access device when the identity of the storage medium is confirmed to be recognizable for the media access device;
decrypting at least one encrypted file using the identity of the storage medium when the identity of the at least one encrypted file is confirmed to be recognizable for the media access device; and
accessing the at least one decrypted file in response to a user command of the media access device.
